(19) United States
(12) Patent Application Publication
(10) Pub. No.: US 2013/0338427 A1
(43) Pub. Date: Dec. 19, 2013

(54) IMPLANTABLE ACTUATOR FOR DIRECT COCHLEA STIMULATION

(71) Applicant: Hannes Maier, Hamburg (CH)

(72) Inventor: Hannes Maier, Hamburg (CH)

(73) Assignee: ADVANCED BIONICS AG, Staefa (CH)

(21) Appl. No.: 13/979,107

(22) PCT Filed: Jan. 11, 2011
(86) PCT No.: PCT/EP2011/050249

§ 371 Date: Sep. 5, 2013

(51) Int. Cl. H04R 25/00

(52) U.S. Cl. CPC H04R 25/65
USPC 600/25

(57) ABSTRACT

There is provided an implantable actuator for direct stimulation of a patient's cochlea comprising a frame to be fluid-tightly fixed within the patient's oval window in a manner to replace the stapes footplate and having an oval shape conforming to the shape of the oval window, a rigid vibration element for acting on the perilymph fluid, which vibration element is guided within the frame, an elastic holding element fixed both at the frame and at the vibration element and extending laterally between the frame and the vibration element for allowing axial movement of the vibration element relative to the frame but preventing lateral movement of the vibration element relative to the frame, and a rod having a first end to be driven by the tympanic membrane, an ossicle or a driver of an at least partially implantable hearing aid and a second end connected to the vibration element for causing reciprocating movement of the vibration element within the frame.

The invention relates to an implantable actuator for direct stimulation of the patient's cochlea.

One concept of implantable actuators for hearing aids uses a piston-type transducer which is inserted within a frame introduced into an artificial hole penetrating through the cochlear wall for directly acting on the perilymph fluid of the cochlea. An example of such actuator is found in EP 0 891 684 B1, wherein the actuator is located at a position adjacent to the oval window. Another example of such actuator is described in US 2009/0141919 A1, wherein the actuator may be located at a position next to the oval window or in the oval window itself and wherein the actuator comprises a piston-like slidably movable member guided within the frame in such a manner that there is a gap of not more than 0.1 mm extending between the inner wall of the frame and the outer wall of the movable member which may be driven by a motor, by the ear drum or by an ossicle.

EP 1 435 757 A1 relates to an actuator, wherein a frame comprising a membrane at its distal end is inserted into an artificial hole drilled into the cochlear wall in such a manner that the endosteal internal lining of the inner ear is preserved. The location is chosen such that it overlaps the scala vestibuli well above the basilar membrane; another possible location is the oval niche. The membrane may be driven by a piston, a piezo-membrane or a fluid-filled tube. A similar actuator is described in US 2006/0161255 A1, wherein the frame may be positioned in the stapes footplate.

WO 2008/077943 A2 relates to an actuator comprising a frame which attached to an artificially drilled hole in the bony wall accessing the scala vestibuli or to the oval window and a rigid plate which is attached to the inner wall of the frame by a flexible suspension. The plate is driven by a conducting element, such as a fixed rod, an adjustable telescopic slip link or an adjustable hinged link, which is driven by a motor fixed within a frame and which is connected to the plate via a wall joint.

Implantable piston-like actuators also may form part of a Total Ossicular Replacement Prosthesis (TORP) wherein the actuator is driven by the tympanic membrane or of a Partial Ossicular Replacement Prosthesis (PORP) wherein the actuator is driven an ossicle.

Known solutions using a piston or piston-like actuator often encounter significant mechanical losses due to acoustic shortcuts and small efficient piston area (typically less than 0.5 mm²); also, instabilities of actuator position may occur, which requires a surgical intervention and repositioning.

It is an object of the invention to provide for an implantable actuator having only little mechanical losses and having high implantation reliability. It is also an object to provide for a method of implanting such actuator.

According to the invention, these objects are achieved by an implantable actuator as defined in claim 1 and an implanting method as defined in claim 22, respectively.

The invention is beneficial in that, by replacing the stapes footplate by a frame which has a shape conforming to the shape of the oval window and which is fluid-tightly fixed within the patient's oval window, for guiding a rigid vibration element acting on the perilymph fluid, with a elastic holding element being fixed both at the frame and at the vibration element and extending laterally between the frame and the vibration element for allowing axial movement of the vibration element relative to the frame but preventing lateral movement of the vibration element relative to the frame, an actuator having only little mechanical losses and having high implantation reliability can be realized.

The actuatot may form part of an at least partially implantable hearing aid, a TORP or a PORP.

Preferred embodiments of the invention are defined in the dependent claims.

Hereinafter, examples of the invention will be illustrated by reference to the attached drawings, wherein:

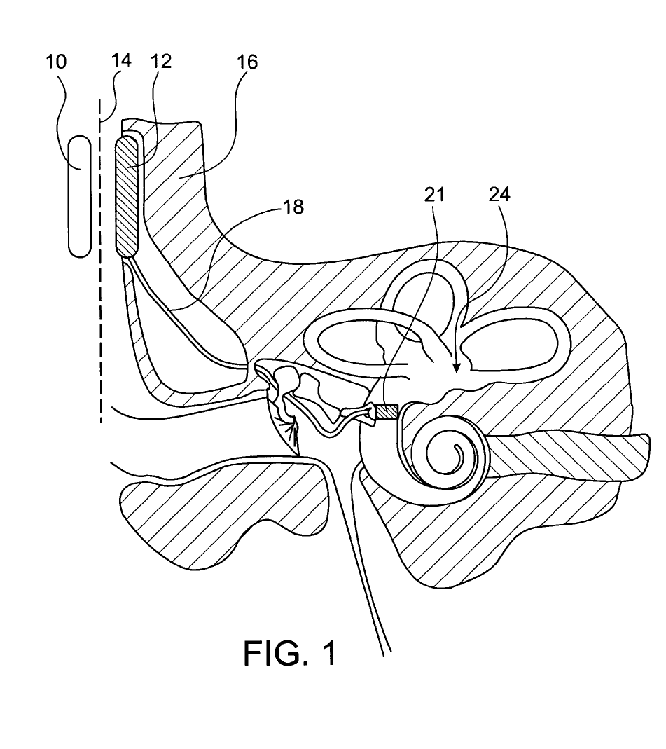

FIG. 1 is a schematic cross-sectional view of an example of a hearing aid comprising an actuator according to the invention after implantation;

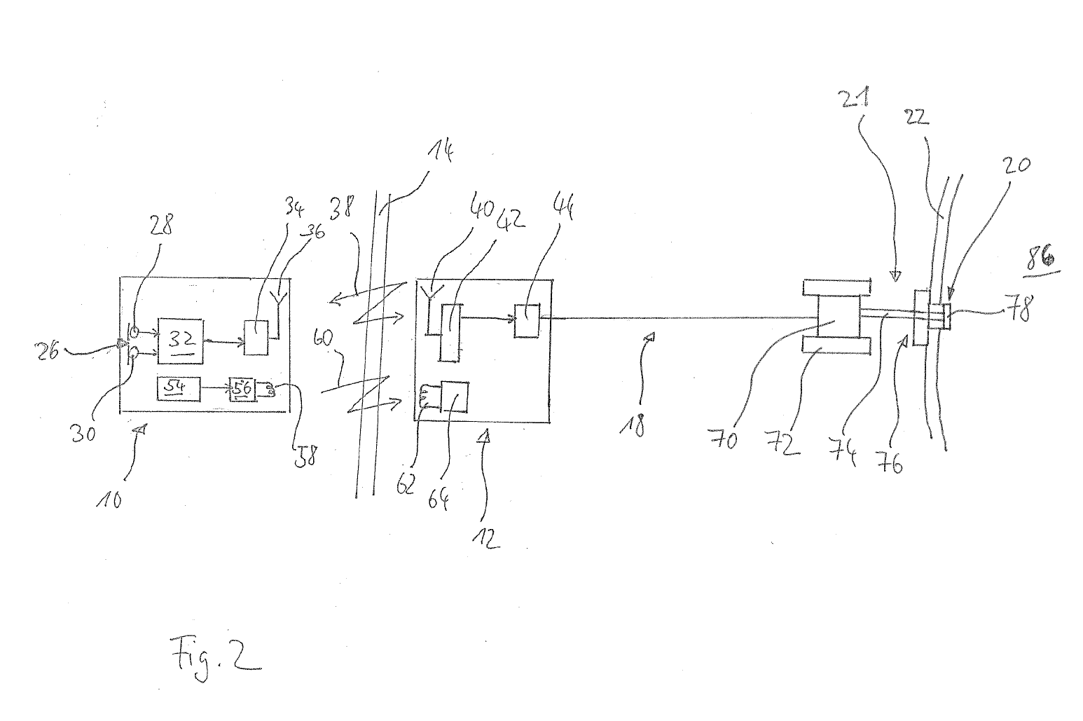

FIG. 2 is a block diagram of the system of FIG. 1;

FIG. 3 is a schematic cross-sectional view of the region of a patient's ear around the stapes footplate;

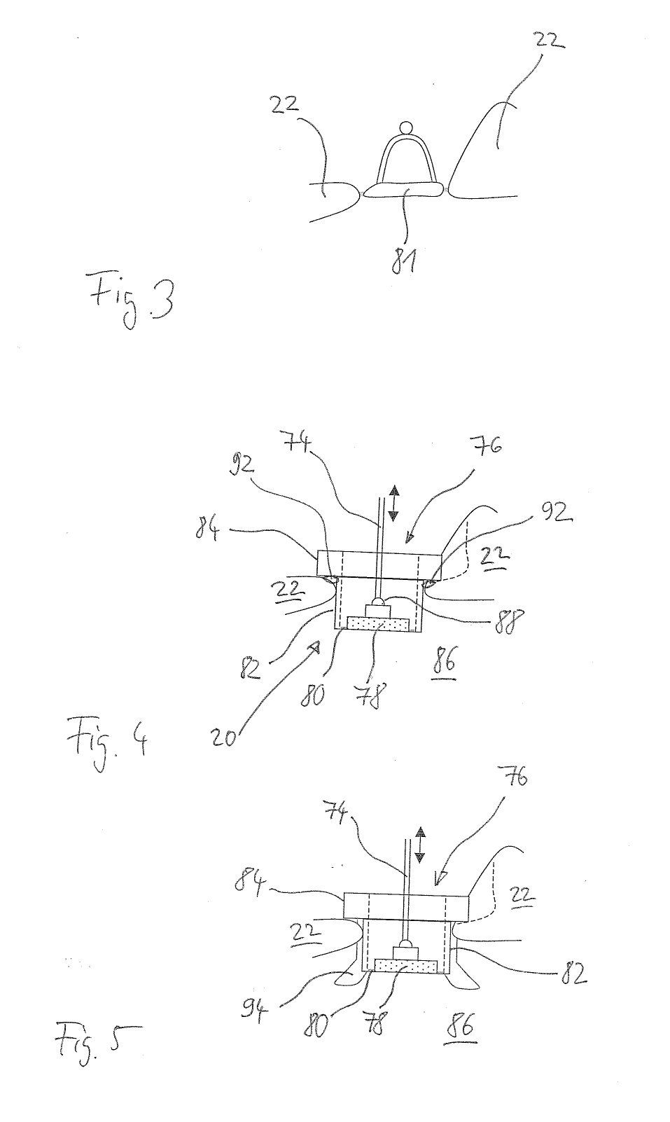

FIG. 4 is a schematic cross-sectional view of the region of FIG. 3 after removal of the stapes footplate and insertion of an actuator according to a first embodiment of the invention; and

FIGS. 5-7 are views like FIG. 4, wherein modified embodiments of the actuator are shown.

FIG. 1 shows a cross-sectional view of the mastoid region, the middle ear and the inner ear of a patient after implantation of an example of a hearing aid comprising an actuator according to the invention, wherein the hearing aid is shown only schematically. The hearing aid comprises an external unit 10 which is worn outside the patients body at the patient's head and an implantable unit 12 which is implanted under the patient's skin 14, usually in an artificial cavity created in the patient's mastoid 16. The implantable unit 12 is connected via a cable assembly 18 to a stimulation assembly 21 comprising a mechanical actuator 20 which is implanted at the wall 22 of the cochlea 24. The external unit 10 is fixed at the patient's skin 14 in a position opposite to the implantable unit 12, for example by magnetic forces created by cooperating fixation magnets provided in the internal unit 10 and the implantable unit 12, respectively (these fixation magnets are not shown in FIG. 1).

An example of a block diagram of the hearing aid of FIG. 1 is shown in FIG. 2. The external unit 12 comprises a microphone arrangement 26 comprising at least one or several spaced-apart microphones 28 and 30 for capturing audio signals from ambient sound, which are supplied to an audio signal processing 32 where they undergo, for example, acoustic beamforming. The audio signals processed by the audio signal processing unit 32 are supplied to a transmission unit 34 connected to a transmission antenna 36 in order to enable transcutaneous transmission of the processed audio signals via an inductive link 38 to the implantable unit 12 which comprises a receiver antenna 40 connected to a receiver unit 42 for receiving the transmitted audio signals. The received audio signals are supplied to a driver circuit 44 which generates the input signals to the stimulation assembly 21 from the received audio signals.

The external unit 10 also comprises a power supply 54 which may be a replaceable or rechargeable battery, a power transmission unit 56 and a power transmission antenna 58 for transmitting power to the implantable unit 12 via a wireless power link 60. The implantable unit 12 comprises a power receiving antenna 62 and a power receiving unit 64 for powering the implanted electronic components with power received via the power link 60. Preferably, the audio signal antennas 36, 40 are separate from the power antennas 58, 62 in order to optimize both the audio signal link 38 and the power link 60. However, if a particularly simple design is desired, the antennas 36 and 58 and the antennas 40 and 62 could be physically formed by a single antenna, respectively.

The stimulation assembly 21 comprises a driver/motor 70 fixed by a frame 72 within an artificial cavity within the patient's middle ear and the mechanical actuator which comprises a rod 74, a frame 76 and a vibration element 78. The frame 72 may be fixed within the mastoid/temporal bone and may comprise means for adjusting the position of the motor 70, as it is known in the art. One end of the rod 74 is connected to the motor 70, and the other end of the rod 74 is connected to the vibration element 78. The motor 70 may be any electro-mechanical transducer, such as a piezo-electric or electro-magnetic transducer. The motor 70 receives the input signals provided by the driver circuitry 44 via the cable assembly 18 and serves to drive the vibration element 78 via the rod 74 in such a manner that it performs a reciprocating movement within the frame 76. The frame 76 is for guiding the vibration element 78 in order to enable such reciprocating movement caused by the rod 74 and the motor 70. An elastic holding element 80 fixed both at the frame 76 and at the vibration element 78 extends laterally between the frame 76 and the vibration element 78 in a manner to allow axial movement of the vibration element 78 relative to the frame 76 but to prevent lateral movement of the vibration element relative to the frame. Optionally, the holding element 80 and may act to seal the gap between the frame 76 and the vibration element 78 in a fluid-tight manner.

The frame 76, the vibration element 78 and the holding element 80 are designed for replacing the stapes footplate 81. To this end, the frame 76 is of oval shape to fit the natural form of the oval window as close as possible. The frame 76 comprises a distal (inner) portion 82 for passing through the oval window and a proximal (outer) flange portion 84 resting on the edge of the oval window on the side facing away from the perilymph 86, with the flange portion 84 having a broader lateral dimension than the distal portion 82. The frame 76 is made of a biocomapatible material, such as titanium or gold

According the embodiments shown in FIGS. 4 to 7 the vibration element 78 may be a plate, which is suspended by an annular membrane acting as the holding element 80 within the frame 76. In this case, the vibration element 78 preferably is located at the distal end of the distal portion 82, i.e. at that end facing the perilymph 86. The membrane 80 is compliant and bio-compatible and may be made, for example, of Teflon or silicone. The membrane 80 allows movements of the plate 78 in the axial direction, but prevents lateral movements and ensures a proper distance to the frame 76 in order to reduce friction. The plate 78 is stiff and may be made, for example, of a bio-compatible ceramics material or of titanium.

The rod 74 preferably is connected to the vibration element 78 via a joint 88 allowing for tilting of the rod 74 relative to the vibration element 78. Preferably, the joint 88 is a ball joint.

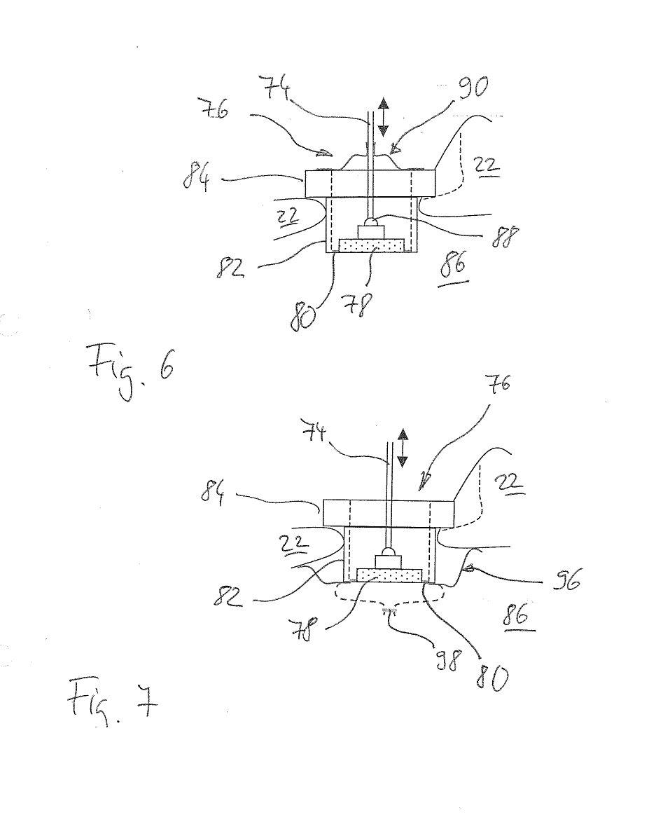

In FIG. 6 an embodiment is shown wherein the rod 74 is provided with stabilization wires 90, which engage with that side of the flange portion 84 facing away from the perilymph 86 in order to counteract tilting motion of the rod 74 relative to the frame 76—and hence relative to the vibration element 78.

There are various alternatives for fixing the frame 76 in a fluid-tight manner within the oval window. According to one embodiment, the flange portion 84 of the frame 76 may be cemented to the edge of the oval window (this is indicated at 92 in FIG. 4).

Alternatively, flange portion 84 of the frame 76 may comprises bendable legs for engagement with the edge of the oval window

According to a further alternative, the distal portion 82 of the frame 76 may comprise a laterally expandable silicone sealing 94 surrounding the periphery of the distal portion 82. The silicone sealing 94 is compressed when the distal portion 84 of the frame 76 is passed through the oval window and thereafter is allowed to expand laterally for securing the frame 76 within the oval window.

According to the embodiment of FIG. 7, the distal portion 82 of the frame 76 may be provided with a laterally unfoldable wire bundle 96 which is kept in a folded condition by a soluble bio-compatible fixation element 98 for allowing the distal portion 84 to penetrate the oval window (this folded condition is indicated in dashed lines in FIG. 7). The fixation element 98 may be designed as ring. Once the fixation element 98 has been solved, the wire bundle 96 will unfold, thereby engaging with the edge of the oval window at that side facing the perilymph 86 (the unfolded condition is shown in solid lines in FIG. 7).

An actuator of the present invention may not only be used with, i.e. driven by, the motor/driver of an implantable hearing aid. Rather, such actuator also may form part of a Total Ossicular Replacement Prosthesis (TORP) wherein the actuator is driven by the tympanic membrane or of a Partial Ossicular Replacement Prosthesis (PORP) wherein the actuator is driven by an ossicle. In such cases, in the embodiments of FIGS. 4 to 7, the proximal end of the rod 74 would be coupled to tympanic membrane or to an ossicle, respectively, rather than to the driver 70.

1. An implantable actuator for direct stimulation of a patient's cochlea comprising a frame to be fluid-tightly fixed within the a patient's oval window in a manner to replace a stapes footplate and having an oval shape conforming to a shape of the oval window, a rigid vibration element for acting on a perilymph fluid, which vibration element is guided within the frame, an elastic holding element fixed both at the frame and at the vibration element and extending laterally between the frame and the vibration element for allowing axial movement of the vibration element relative to the frame but preventing lateral movement of the vibration element relative to the frame, and a rod having a first end to be driven by a tympanic membrane, an ossicle or a driver of an at least partially implantable hearing aid and a second end connected to the vibration element for causing reciprocating movement of the vibration element within the frame.

2. The actuator of claim 1, wherein the frame comprises a distal portion for passing through the oval window and a flange portion for resting on an edge of the oval window on a side facing away from the perilymph, the flange portion having a broader lateral dimension than the distal portion.

3. The actuator of claim 2, wherein the flange portion of the frame is to be cemented to the edge of the oval window.

4. The actuator of claim 2, wherein the flange portion of the frame comprises bendable legs for engagement with the edge of the oval window.

5. The actuator of claim 2, wherein the distal portion of the frame comprises a laterally expandable silicone sealing surrounding a periphery of the distal portion.

6. The actuator of claim 2, wherein the distal portion of the frame comprises a laterally unfoldable wire bundle for engaging with the edge of the oval window.

7. The actuator of claim 6, wherein the wire bundle is to be kept in a folded condition by a soluble biocompatible fixation element for allowing the distal portion to penetrate the oval window.

8. The actuator of claim 7, wherein the fixation element is a ring.

9. The actuator of claim 1, wherein the vibration element is plate-like and wherein the actuator element is an annular membrane for suspending the vibration element within the frame.

10. The actuator of claim 9, wherein the membrane is made of Teflon or silicone.

11. The actuator of claim 9, wherein the vibration element is located at that end of the distal portion of the frame facing the perilymph.

12. The actuator of claim 1, wherein the vibration element is made of ceramics or titanium.

13. The actuator of claim 1, wherein the second end of the rod is connected to the vibration element via a joint allowing for tilting motion of the rod relative to the vibration element.

14. The actuator of claim 13, wherein the joint is a ball joint.

15. The actuator claim 13, wherein stabilizing wires attached to the rod are provided for engaging with that side of the flange portion of the frame facing away from the perilymph in order to counteract tilting motion of the rod relative to the frame.

16. The actuator of claim 1, wherein the vibration element is for direct contact with the perilymph.

17. The actuator of claim 1, wherein the holding element is for providing a fluid-tight sealing of a gap between the frame and the vibration element.

18. An at least partially implantable hearing aid comprising an actuator of claim 1, further comprising means for capturing audio signals from ambient sound, an audio signal processing unit for transforming the audio signals into input signals to a driver connected to the first end of the rod of the actuator.

19. The hearing aid of claim 18, wherein the hearing aid comprises an external unit comprising the means for capturing audio signals from ambient sound and the audio signal processing unit, and an implantable unit, the external unit comprising means for transmitting processed audio signals to the implantable unit via a wireless transcutaneous link, the implantable unit comprising means for receiving the processed audio signals an supplying it as the input signals to the driver.

20. The actuator of claim 1, wherein the first end of the rod is adapted to be driven by the tympanic membrane.

21. The actuator of claim 1, wherein the first end of the rod is adapted to be driven by an ossicle.

22. A method for implanting an actuator into a patient's ear, comprising
removing the stapes footplate;
inserting the frame into the oval window; and
fixing the frame in a fluid-tight manner within the oval window.
